(19) United States
(12) Patent Application Publication
(10) Pub. No.: US 2012/0199214 A1
(43) Pub. Date: Aug. 9, 2012

(54) BRAKE MODULATOR AND METHOD OF PROCESSING BRAKE MODULATOR DURING VEHICLE ASSEMBLY

(75) Inventors: Josef MACK, Allenton, MI (US); Raymond J. SAPIENZA, Fenton, MI (US); Brian D. COTTON, Clauson, MI (US); Phanu AMATYAKUL, Brighton, MI (US); Paul S. SHAUB, Detroit, MI (US); Frank J. PICHLER, JR., Washington, MI (US); Elizabeth A. CONLIN, Waterford, MI (US)

(73) Assignee: GM GLOBAL TECHNOLOGY OPERATIONS LLC, DETROIT, MI (US)

(21) Appl. No.: 13/024,024

(22) Filed: Feb. 9, 2011

(51) Int. Cl. B67C 3/16

(52) U.S. Cl. 137/205

(57) ABSTRACT

A brake modulator is disclosed herein. The brake modulator includes, but is not limited to an electronic-brake-control-modulator portion including a processor and a hydraulic portion associated with the electronic-brake-control-modulator portion. The hydraulic portion includes a primary circuit extending through the hydraulic portion to receive hydraulic brake fluid. The hydraulic portion also includes a secondary circuit extending within the hydraulic portion to receive the hydraulic brake fluid. The secondary circuit is in fluid communication with the primary circuit. The hydraulic portion further includes a valve between the primary circuit and the secondary circuit. The valve is electronically actuatable and controls movement of fluid between the primary circuit and the secondary circuit. The processor is operatively coupled to the valve and configured to perform an automatic cycling of the valve in response to an actuating event during assembly of the vehicle to evacuate the secondary circuit.

### TECHNICAL FIELD

The technical field generally relates to vehicles, and more particularly relates to a brake modulator for use with a brake system of a vehicle and a method of processing the brake modulator during assembly of the vehicle.

### BACKGROUND

A conventional anti-lock brake system employs a brake modulator that is configured to rapidly pulse a vehicle's brakes when a vehicle skid is detected to inhibit the brakes from locking up. The brake modulator includes a hydraulic portion that is configured to be fluidly connected to the vehicle's brake system such that hydraulic brake fluid running through the vehicle's brake lines also runs through the hydraulic portion. The brake modulator also includes an electronic-brake-control-module portion that includes a processor that is configured to control the pulsing of the vehicle's brakes.

The hydraulic portion includes one or more primary circuits that extend through the hydraulic portion and that are configured to carry the hydraulic brake fluid. The hydraulic portion further includes one or more secondary circuits that extend within the hydraulic portion and that also carry the hydraulic brake fluid. The primary circuit and the secondary circuit are fluidly connected to one another, and a valve is situated between the two circuits to control the passage of fluid from one circuit to the other. The processor of the electronic-brake-control-module portion is connected to the valve and is configured to control the opening and closing of the valve (referred to herein as “cycling” the valve). During normal brake operations (i.e., when rapid pulsing of the brakes is not required), the valve remains closed and, accordingly, hydraulic brake fluid does not pass between the primary and secondary circuits. When a skid is detected or when the vehicle's antilock brake system is otherwise actuated (for other optional brake system control features, such as traction control) and the vehicle's brakes need to be pulsed, the processor instructs the valves to cycle, as needed, to allow the hydraulic brake fluid to flow into and out of the secondary circuit, as required, to accomplish the enhanced braking functions.

When a vehicle is being assembled by an original equipment manufacturer (referred to herein as an “OEM”), the vehicle's brake system is filled with the hydraulic brake fluid. The first step in this process entails evacuating the brake system by exposing the brake lines to a vacuum. The purpose of this is to remove all air from the brake lines. Once the brake system has been evacuated, then the hydraulic brake fluid is introduced into the brake lines.

The brake modulator must also be evacuated and filled with the hydraulic brake fluid. In some embodiments, the brake modulator comes to the OEM with completely dry primary and secondary circuits. In this case, both the primary and the secondary circuits are filled with hydraulic brake fluid at the brake evacuation and filling station at the OEM plant. This embodiment shall be referred to herein as the “conventional cycling” method of processing.

In other embodiments, only the primary circuit is evacuated and filled at the evacuation and filling station in the OEM plant. In this case, there are two variations.

The first variation requires the secondary circuits to come from the brake module supplier in a pre-evacuated and filled condition. In this case, the primary circuits still comes in completely dry and gets evacuated and filled by the OEM evacuation and fill system and the secondary circuits need no OEM plant processing. This method shall be referred to herein as the “pre-fill” method of processing.

The second variation requires the module to come from the supplier with both primary and secondary circuits dry as in conventional cycling. However, in this approach the secondary circuit remains dry during the evacuation and filling process due to specially designed internal valves. These valves allow air to be removed from the secondary circuit, without electrical actuation but do not allow passage of fluid into the secondary circuit without electrical actuation. In this case, the secondary circuit remains evacuated but not filled until the first time that the anti-lock braking system electrically opens the valves later in the assembly process at a separate downstream station. The special valves which enable this processing method are proprietary to particular brake control module suppliers (only one supplier is presently known to possess this technology). This document will not address this particular method further as it is not relevant to the new technology disclosed herein.

If the electronic brake control module is delivered to the OEM completely dry, and therefore requires conventional cycling, then additional labor, processing, and equipment are required to evacuate and fill the brake system. The OEM must provide a dedicated computer (in addition to the one used to control the other portions of the evacuation and filling process), a communication protocol converter and a unique electronic connector to control the brake modulator during the evacuation and filling process. The connector must be plugged into to a receptacle on the brake modulator. Because the brake modulator is mounted on the vehicle at this point in the assembly process, this receptacle is often difficult to access. Once the connection is made, the OEM can control the valves between the primary and the secondary circuits during the evacuation and filling of the brake system to extract air from the secondary circuit and to load hydraulic brake fluid into the secondary circuits.

When the brake modulator is delivered to the OEM in a pre-filled condition, the OEM can avoid the additional labor, processing, and equipment that is required to process a dry electronic brake control module. However, suppliers may charge a much higher price for a pre-filled electronic brake control module than for a dry electronic brake control module.

### SUMMARY

Various embodiments of an electronic brake control module for use with a brake system on a vehicle and various examples of methods of processing the electronic brake control module during assembly of a vehicle are disclosed herein.

Various embodiments of a brake modulator for use with a brake system on a vehicle and various embodiments of a method for processing the brake modulator during vehicle assembly are disclosed herein.

In a first embodiment, the brake modulator includes, but is not limited to, an electronic-brake-control-modulator portion including a processor and a hydraulic portion associated with the electronic-brake-control-modulator portion. The hydraulic portion includes a primary circuit that extends through the hydraulic portion and that is configured to receive a hydraulic brake fluid. The hydraulic portion further includes a secondary circuit that extends within the hydraulic portion and that is configured to receive the hydraulic brake fluid. The secondary circuit is in fluid communication with the primary circuit. The hydraulic portion still further includes a valve disposed between the primary circuit and the secondary circuit. The valve is configured to be electronically actuatable and to control movement of fluid between the primary circuit and the secondary circuit. The processor is operatively coupled to the valve and is configured to perform an automatic cycling of the valve in response to an actuating event during assembly of the vehicle wherein the valve is cycled to permit evacuation of the secondary circuit.

In another embodiment, the method for processing a brake modulator during vehicle assembly includes, but is not limited to, connecting the brake modulator to a brake system of the vehicle. The method further includes actuating an electronic-brake-control-module portion of the brake modulator to begin an automatic cycling of a valve disposed between a primary circuit and a secondary circuit of a hydraulic portion of the brake modulator. The method further includes conducting the automatic cycling of the valve. The method still further includes evacuating the brake system, the primary circuit and the secondary circuit of the hydraulic portion of the brake modulator during the automatic cycling of the valve.

In another embodiment, the method for processing a brake modulator during vehicle assembly includes, but is not limited to, connecting the brake modulator to a brake system of the vehicle. The method further includes energizing an electronic-brake-control-module portion of the brake modulator. The method further includes transmitting an actuating signal to the electronic-brake-control-module portion configured to actuate an automatic cycling of a valve disposed between a primary circuit and a secondary circuit of a hydraulic portion of the brake modulator. The method further includes conducting the automatic cycling of the valve. The method further includes evacuating the brake system, the primary circuit and the secondary circuit during the automatic cycling of the valve. The method still further includes filling the brake system, the primary circuit and the secondary circuit with the hydraulic brake fluid during the automatic cycling of the valve.

### DESCRIPTION OF THE DRAWINGS

One or more embodiments will hereinafter be described in conjunction with the following drawing figures, wherein like numerals denote like elements, and

FIG. 1 is a schematic view illustrating an embodiment of a brake modulator made in accordance with the teachings disclosed herein;

FIG. 2 is a schematic view illustrating a brake system of a vehicle employing the brake modulator of FIG. 1 and processing equipment for processing the brake system during vehicle assembly;

FIG. 3 is a schematic view illustrating the brake system of FIG. 2 when the vehicle has been energized by the processing equipment;

FIG. 4 is a schematic view of the brake system of FIG. 3 when an actuating signal has been sent to the brake modulator during an evacuation of the brake system;

FIG. 5. is a schematic view of the brake system of FIG. 4 when an automatic cycling of a valve commences during evacuation of the brake system;

FIG. 6 is a schematic view of the brake system of FIG. 5 at a subsequent stage of the automatic cycling of the valve during evacuation of the brake system;

FIG. 7 is a schematic view of the brake system of FIG. 6 at a subsequent stage of the automatic cycling of the valve during a filling of the brake system with hydraulic brake fluid;

FIG. 8 is a schematic view of the brake system of FIG. 7 at a subsequent stage of the automatic cycling of the valve during the filling of the brake system with hydraulic brake fluid;

FIG. 9 is a schematic view of the brake system of FIG. 8 after completion of the automatic cycling of the valve;

FIG. 10 is a block diagram illustrating an embodiment of a method for processing a brake modulator during vehicle assembly; and

FIG. 11 is a block diagram illustrating another embodiment of a method for processing a brake modulator during vehicle assembly.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

An improved brake modulator is disclosed herein. In an embodiment, the brake modulator includes an electronic-brake-control-module portion and a hydraulic portion. The hydraulic portion includes a primary circuit and a secondary circuit that are in fluid communication with one another. Both the primary circuit in the secondary circuit are configured to carry hydraulic brake fluid. Valves are positioned between the primary circuit and the secondary circuit to control the flow of fluid between the two circuits. The valves control the flow of all fluids including, but not limited to, hydraulic brake fluid and air between the two circuits.

The electronic-brake-control-module portion includes a processor that is operatively coupled to the valves in the hydraulic portion. The processor is configured to automatically cycle the valves during vehicle assembly. As used herein, the term “automatically cycle the valves” or “automatic cycling of the valves” or “auto cycle the valves” or “auto cycling of the valves” refers to a function of the brake modulator wherein the valves are cycled through an open condition and a closed condition for a predetermined period of time and wherein the opening and closing of the valves is controlled by the processor of the electronic-brake-control-module portion, not by an external controller. In some embodiments, the processor may be configured to hold the valve open for substantially the entire predetermined period of time while in other embodiments, the processor may be configured to open and close the valve multiple times during the predetermined period of time. In yet other embodiments, pump motors located in the module may be cycled in addition to the valves, as needed, and as determined by the brake module supplier. Pump cycling will not be mentioned further as it is assumed to be part of the overall valve cycling process when determined to be necessary by the supplier. Such automatic cycling of the valves during vehicle assembly will permit the vacuum that is applied to the brake lines of the brake system to extract substantially all of the air out of both the primary circuit and the secondary circuit. The automatic cycling of the valves will also permit the filling of both the primary and secondary circuits with hydraulic brake fluid.

The automatic cycling of the valve may be triggered by an actuating event that occurs during assembly of the vehicle. In some embodiments, the brake modulator is configured to initiate the automatic cycling each time that the brake modulator is energized until the brake modulator has been continuously energized for a predetermined period of time. Being ‘energized’ means that the brake modulator receives electrical power on particular pins of its connector receptacle and also that it receives power on other pin(s) that, in effect, wake up the module. The latter shall be referred to as the ‘comm. enable’ signal. None of these power signals constitute ‘full communication’ to the module as one would see if one were to enact conventional cycling of the module.

During vehicle assembly, when processing a brake system that includes the brake module discussed above, the brake module is connected to the vehicle's brake system, the automatic cycling is actuated, and then the automatic cycling of the valves occur while an evacuation and filling of the vehicle's brake system takes place. This allows assembly line workers to evacuate and fill both the primary and the secondary circuit of the electronic brake control module with hydraulic brake fluid.

After some predetermined period of time with power on and the auto cycling of the valves underway, the processor will set a memory point and will no longer initiate the auto cycling of the valves upon future power on conditions. The brake module will keep an internal record of whether this milestone has been reached on that particular unit. Prior to this milestone, any change in state from power off to power on shall initiate the auto cycling of the valves.

A greater understanding of the embodiments of the electronic brake control module and method for processing the electronic brake control module during assembly of a vehicle may be obtained through a review of the illustrations accompanying this application together with a review of the detailed description that follows.

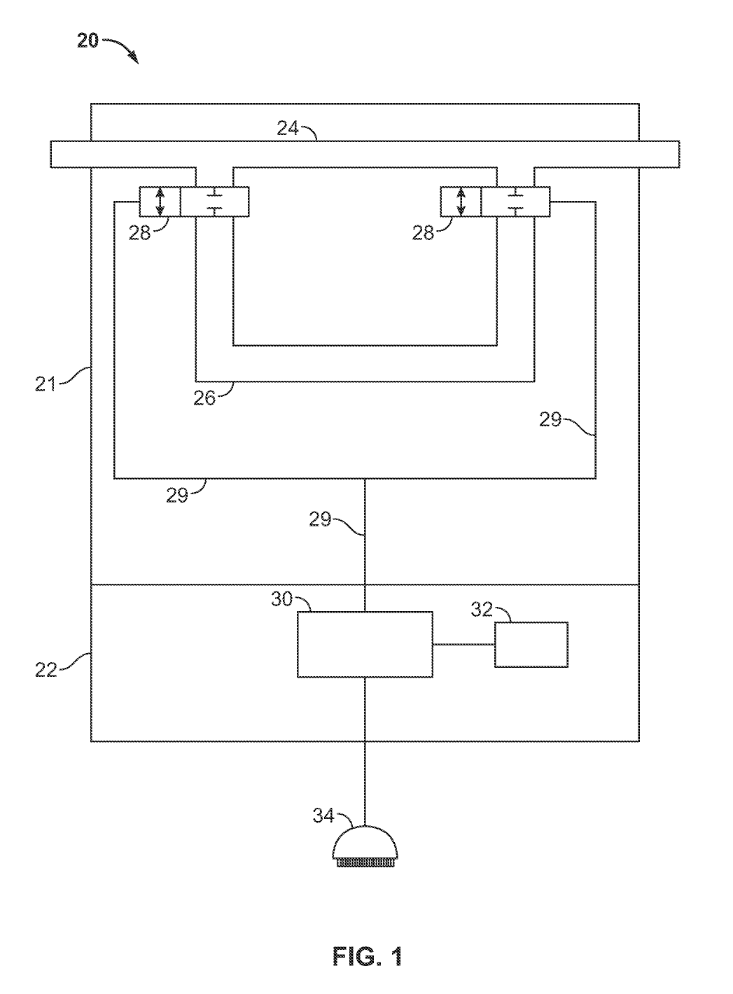

FIG. 1 is a schematic view illustrating an embodiment of a brake modulator 20. Brake modulator 20 is configured for connection to a brake system of a vehicle (not shown). In the illustrated embodiment, brake modulator 20 includes two distinct portions, a hydraulic portion 21 and an electronic-brake-control-module portion 22 (also known as an electronic brake control module).

Hydraulic portion 21 includes a primary circuit 24 that extends through hydraulic portion 21 and that is configured to be connected to hydraulic lines of the vehicle's brake system. Hydraulic portion 21 also includes a secondary circuit 26 that extends entirely within hydraulic portion 21 and which is not directly connected to the hydraulic lines of the vehicle's brake system. Hydraulic portion 21 commonly includes at least two primary circuits 24 and two secondary circuits 26, but for the purposes of simplification, only a single primary circuit 24 and a single secondary circuit 26 are illustrated. Primary circuit 24 and secondary circuit 26 are each configured to serve as a conduit for a fluid such as hydraulic brake fluid, and may have any suitable configuration that is effective to carry out that function. Primary circuit 24 and secondary circuit 26 may be made of any suitable material including any suitable polymeric material, organic material and/or metal material that is effective to contain hydraulic brake fluid.

Hydraulic portion 21 further includes two valves 28 disposed between primary circuit 24 and secondary circuit 26. In other embodiments, a greater or lesser number of valves 28 may be employed. Valves 28 are configured to control the movement of fluid between primary circuit 24 and secondary circuit 26. In the embodiment illustrated in FIG. 1, valves 28 are depicted in the closed position and thus inhibit the flow of fluid between primary circuit 24 and secondary circuit 26. Valves 28 are configured to be electronically actuated and may comprise any type of valve that is effective to control the transmission of hydraulic brake fluid between primary circuit 24 and secondary circuit 26.

Electronic-brake-control-module portion 22 includes a processor 30. Processor 30 may be any type of computer, computer system, microprocessor, collection of logic devices, a state machine, or any other analog or digital circuitry that is configured to calculate, and/or to perform algorithms, and/or to execute software applications, and/or to execute sub-routines, and/or to be loaded with and to execute any type of computer program. Processor 30 may comprise a single processor or a plurality of processors acting in concert. Processor 30 is operatively coupled to valve 28. Such operative couplings may be made through the use of any suitable means of transmission including, but not limited to, a wired connection such as wire 29. Processor 30 is configured (e.g., loaded with, and capable of executing, suitable computer code, software and/or applications) to actuate valve 28.

In the illustrated embodiment, electronic-brake-control-module portion 22 further includes an electronic data storage unit 32. Other embodiments may not include electronic data storage unit 32 while still other embodiments may includes multiple electronic data storage units 32. Electronic data storage unit 32 may be any type of electronic memory device that is configured to store data. For example, electronic data storage unit 32 may include, without limitation, non-volatile memory, disk drives, tape drives, and mass storage devices and may include any suitable software, algorithms and/or sub-routines that provide the data storage component with the capability to store, organize, and permit retrieval of data. In some embodiments, electronic data storage unit 32 may comprise only a single component. In other embodiments, electronic data storage unit 32 may comprise a plurality of components acting in concert. Electronic data storage unit 32 is operatively coupled with processor 30, and processor 30 is configured to send and retrieve data and/or data files to and from electronic data storage unit 32.

Electronic-brake-control-module portion 22 further includes a connector 34. Connector 34 is configured to connect brake modulator 20 to a wiring harness of the vehicle. Electronic-brake-control-module portion 22 may utilize connector 34 to communicate with, or otherwise interact with, a central processing unit of the vehicle and/or other components of the vehicle.

Brake modulator 20 is configured to control the transmission of hydraulic brake fluid through a brake system of a vehicle and to control the pulsing of the vehicle's brakes under certain traction related conditions. Brake modulator 20 may be used with any type of vehicle that utilizes wheels and brakes to retard locomotion.

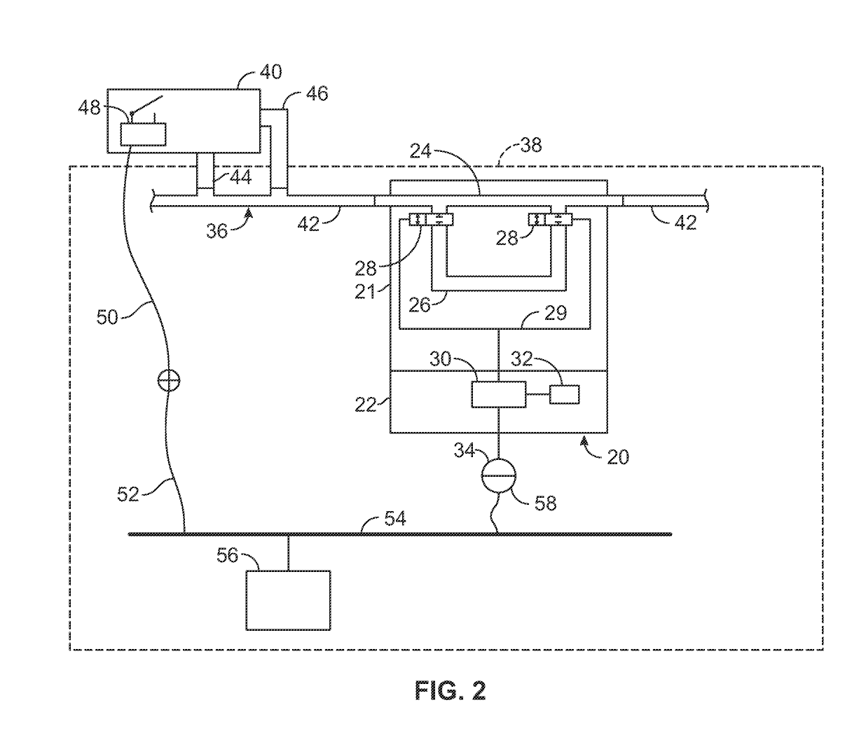

FIG. 2 is a schematic view illustrating a brake system 36 of a vehicle 38. It should be understood that brake system 36 has been illustrated in a simplified manner and that many components have been omitted. In FIG. 2, vehicle 38 is situated on an assembly line at a vehicle assembly plant and processing equipment 40 has been connected to brake system 36. Processing equipment 40 is configured to evacuate brake system 36 and then fill brake system 36 with hydraulic brake fluid during vehicle assembly. Brake system 36 includes, but is not limited to, multiple brake lines 42, brake calipers and associated hardware (not shown), an operator-actuatable brake pedal (not shown), and a master cylinder (not shown). Brake system 36 also includes brake modulator 20. Brake modulator 20 is configured to connect to brake system 36, and brake system 36 is configured to support brake modulator 20 in a position that permits primary circuit 24 to fluidly connect with brake lines 42. In this manner, fluid may pass between brake lines 42 and primary circuit 24. Hydraulic fluid will also pass through secondary circuit 26, but such hydraulic fluid must first pass through primary circuit 24.

Each brake line 42 transmits hydraulic brake fluid between the master cylinder and the brake calipers which are located at the wheels of vehicle 38. During vehicle assembly, brake lines 42 and primary circuit 24 and secondary circuit 26 are evacuated to remove substantially all air from brake system 36. Such evacuation will help to avoid excessive brake pedal travel when an operator engages the brakes of vehicle 38. To evacuate the air from brake system 36, processing equipment 40 includes a vacuum tube 44. Vacuum tube 44 is connected to brake line 42. When actuated, vacuum tube 44 exposes brake lines 42 to a vacuum which evacuates substantially all air from brake system 36.

Processing equipment 40 also includes a hydraulic brake fluid dispensing tube 46 that is connected to brake line 42. When actuated, processing equipment 40 introduces hydraulic brake fluid into brake lines 42 via hydraulic brake fluid dispensing tube 46.

Processing equipment 40 also includes a power supply 48. Power supply 48 includes a power line 50 which is configured for connection to an electrical system of vehicle 38. In some examples, power line 50 may connect to a battery cable 52 of vehicle 38. In other examples, power line 50 may connect to another junction of the electrical system. Power supply 48 is configured to provide 12 V of electricity to the electrical system of vehicle 38 during vehicle assembly.

In the illustrated example, battery cable 52 is connected to vehicle bus 54. Via this connection, the power that is supplied by power supply 48 is transmitted to the various components which are connected to vehicle bus 54. In other embodiments, a separate power line in vehicle 38 may be utilized for the transmission of power to the various components of vehicle 38 which require power. An exemplary component 56 is communicatively connected to vehicle bus 54. Component 56 is configured to communicate with other components of vehicle 38 across vehicle bus 54. In some embodiments, component 56 may comprise a body control module that is configured to control various vehicle-body related functions.

Connector 34 is connected to wiring harness 58. Through this connection to wiring harness 58, brake modulator 20 is communicatively connected to vehicle bus 54 and to some or all other components connected to vehicle bus 54. Brake modulator 20 also receives power from power supply 48 via the connection between connector 34 and wiring harness 58.

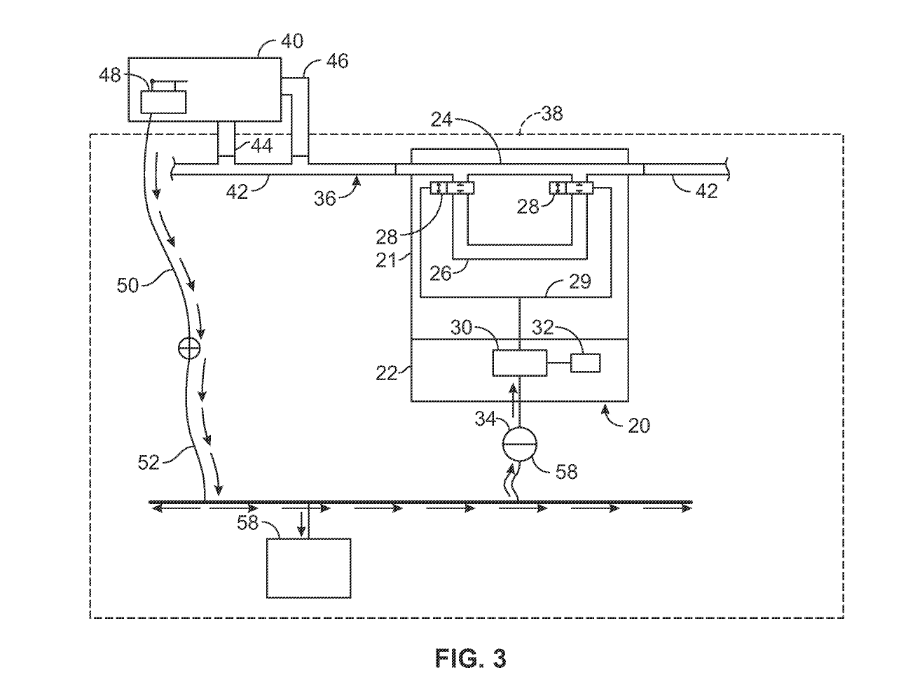

FIG. 3 is a schematic view illustrating brake system 36 when vehicle 38 has been energized by power supply 48. As illustrated by the arrows depicted in FIG. 3, power flows from power supply 48 power line 50 to battery cable 52 and then into vehicle bus 54. Vehicle bus 54 carries the power to component 56 and then on to brake modulator 20. In some embodiments, once processor 30 detects the presence of electrical power, it may be configured to commence the automatic cycling process. In other embodiments, such as the embodiment depicted in FIGS. 1-9, actuation of the automatic cycling process will require the transmission of an actuating signal to processor 30. As illustrated in FIG. 3, valves 28 remains closed and fluid is inhibited from traveling between secondary circuit 26 and primary circuit 24.

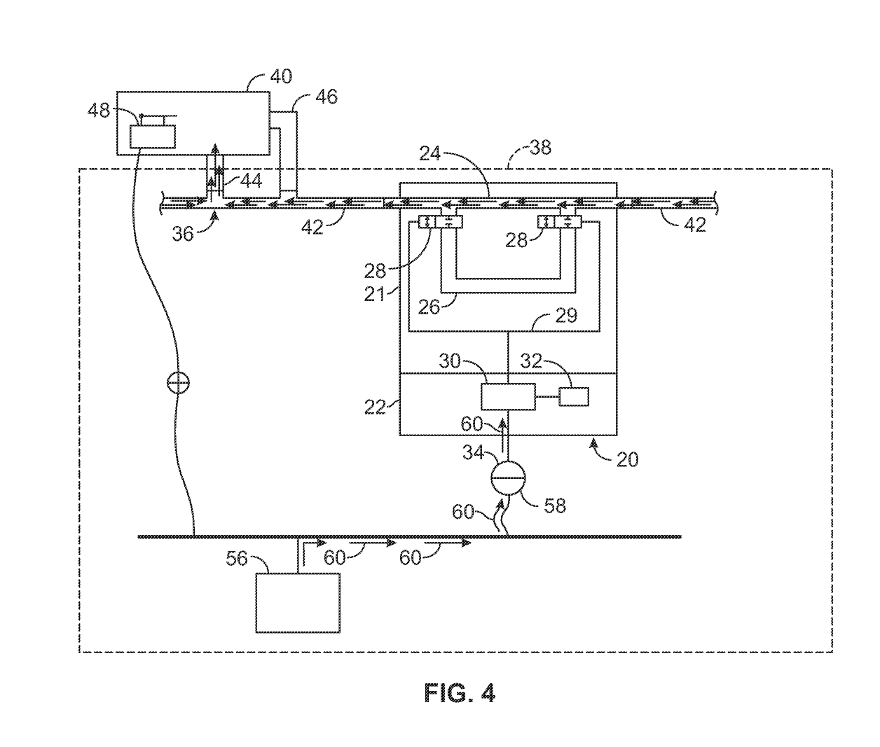

FIG. 4 is a schematic view of brake system 36 when an actuating signal 60 is sent to brake modulator 20. In the illustrated embodiment, actuating signal 60 originates from component 56 on vehicle 38. In an exemplary embodiment, component 56 may be the body control module and may be configured to transmit actuating signal 60 to brake modulator 20 when component 56 detects the presence of electric power. In such embodiments, actuating signal 60 may be a standard or conventional “wake up” command that is typically sent out by the body control module when a vehicle is first started or when some component on the vehicle is actuated by a user. In other embodiments, component 56 may be configured to transmit actuating signal 60 after some predetermined period of time lapses after the presence electric power is initially detected. In other embodiments, actuating signal 60 may be sent by any other component of vehicle 38. In other embodiments, actuating signal 60 may be sent by processing equipment 40. In still other embodiments, actuating signal 60 may be sent by any suitable device effective to communicate with brake modulator 20.

In the illustrated embodiment, actuating signal 60 is sent to brake modulator 20 after an evacuation of brake system 36 has already begun. In some embodiments, processor 30 may be configured to commence the automatic cycling of valves 28 immediately upon detection of actuating signal 60 while in other embodiments, processor 30 may be configured to wait for a predetermined period of time before commencing the automatic cycling of valves 28. The embodiment illustrated in FIG. 4 is configured to delay commencement of the automatic cycling of valves 28 for a predetermined period of time (e.g., 15 seconds). A time lapse before the automatic cycling of valves 28 begins may be needed to give operators on the assembly line an opportunity to check the vacuum seal between vacuum tube 44 and brake line 42. If the vacuum seal is bad, the operators can cut power to vehicle 38 and prevent the automatic cycling of valves 28 from commencing until a good vacuum seal can be obtained. As illustrated in FIG. 4, the automatic cycling of valves 28 has not yet begun and valves 28 remains closed. Accordingly, while air from primary circuit 24 is being evacuated, air from secondary circuit 26 is not being evacuated.

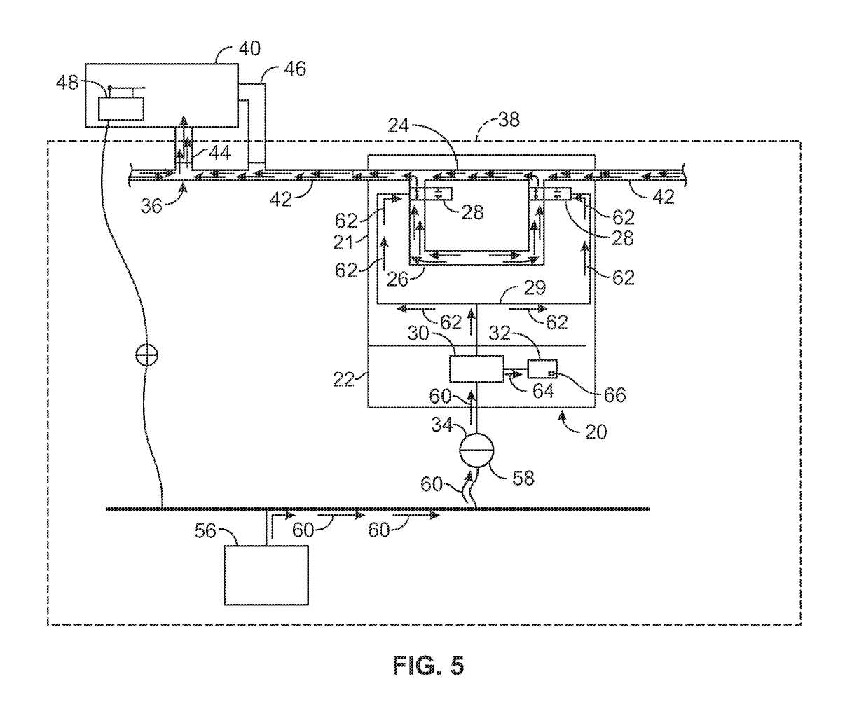

FIG. 5. is a schematic view of brake system 36 as air is being evacuated from brake lines 42 and as an automatic cycling of valves 28 commences. As part of the automatic cycling process, processor 30 sends an open instruction 62 to valves 28 which opens valves 28. The opening of valves 28 permits air that is present in secondary circuit 26 to be evacuated through valves 28 into primary circuit 24, and then in to brake line 42 and then out of brake system 36 through vacuum tube 44. In some embodiments, processor 30 may be configured to retain valves 28 in an open state throughout the evacuation of brake system 36.

When the automatic cycling of valves 28 begins, processor 30 is further configured to transmit a first record instruction 64 to electronic data storage unit 32. First record instruction 64 instructs electronic data storage unit 32 to record information in a first file 66 indicating that the automatic cycling of valves 28 has commenced. The recording of information in electronic data storage unit 32, such as first file 66, will permit technicians, at a later date, to investigate which stages of the evacuation and fill of brake modulator 20 were successfully completed in the event that there is ever a warranty claim or a maintenance issue relating to brake modulator 20.

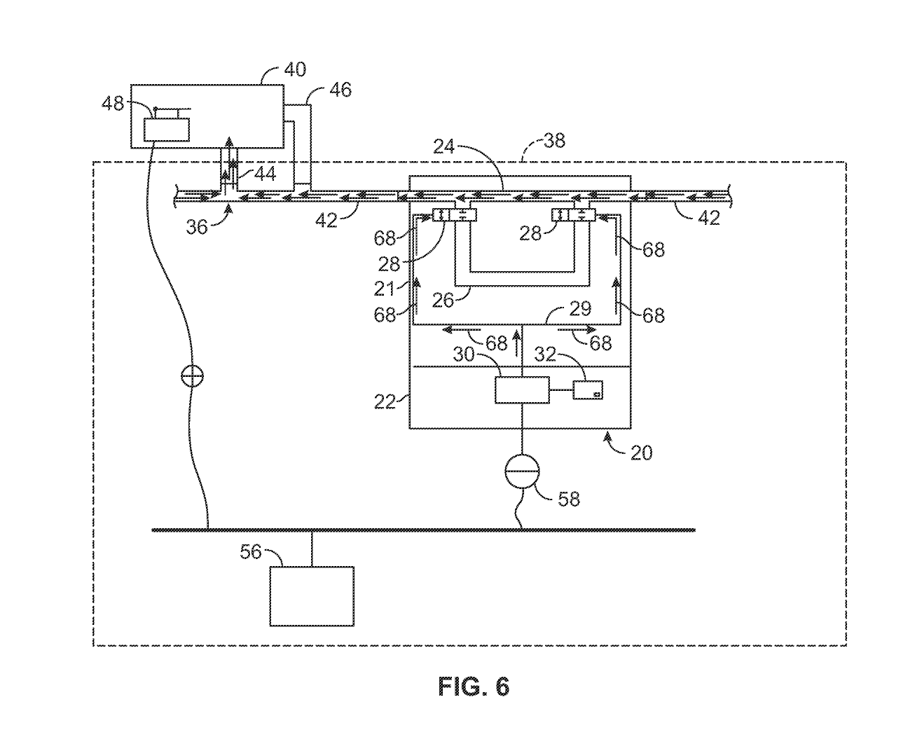

FIG. 6 is a schematic view of brake system 36 during evacuation of the brake system and after the automatic cycling of valves 28 is underway. With continuing reference to FIGS. 1-6, the stage of the automatic cycling process illustrated in FIG. 6, processor 30 transmits a close instruction 68 to valve 28. In response, valves 28 close and inhibit further evacuation of secondary circuit 26 during the period of time that valves 28 remains closed. After a predetermined period of time, processor 30 will again transmit open instruction 62 to permit further evacuation of secondary circuit 26. In some embodiments, processor 30 will transmit open instruction 62 and close instruction 68 multiple times during the evacuation. Repeated opening and closing of valves 28 may be required to give valves 28 an opportunity to rest in the closed position to avoid overheating or other mechanical complications.

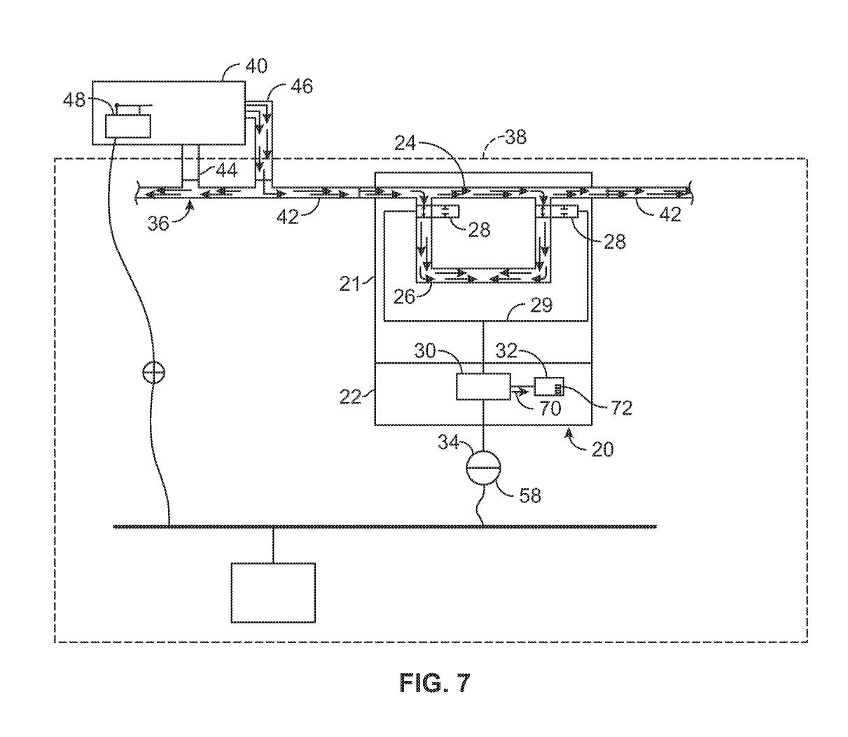

FIG. 7 is a schematic view of brake system 36 at a subsequent stage of the automatic cycling of valves 28 after evacuation of brake system 36 is complete and a filling of brake system 36 with hydraulic brake fluid has begun. In the embodiment illustrated in FIG. 7, valves 28 remains open to permit hydraulic brake fluid to enter secondary circuit 26. In some embodiments, processor 30 may be configured to instruct valves 28 to remain open while brake system 36 is filled with hydraulic brake fluid. In other embodiments, processor 30 may be configured to instruct valves 28 to open and close multiple times throughout the filling of brake system 36 to permit valves 28 to periodically rest in the closed position during the fill process.

In the illustrated embodiment, processor 30 is further configured to send a second record instruction 70 to electronic data storage unit 32 when the filling of brake system 36 with hydraulic brake fluid begins. Second record instruction 70 may instruct electronic data storage unit 32 to store a second file 72. Second file 72 may include information indicating that the automatic cycling of valves 28 has progressed throughout the evacuation of brake system 36 and has continued beyond the point where hydraulic brake fluid is introduced into brake system 36.

Processor 30 may be programmed by a supplier that is familiar with the timing of the evacuation and filling cycle employed by the OEM. This allows the supplier to configure processor 30 to wait for a predetermined period of time after commencement of the automatic cycling of valves 28 before sending second record instruction 70 to electronic data storage unit 32. The predetermined period of time can correspond with the amount of time that the OEM devotes to evacuating brake system 36.

In some embodiments, prior to the recording of second file 72, brake modulator 20 is configured to permit the automatic cycling of valves 28 to start over if the automatic cycling process is interrupted for any reason. For example, if, after the automatic cycling of valves 28 commences, an operator on the assembly line discovers that there is a bad seal between vacuum tube 44 and brake line 42, the operator may stop evacuation of brake system 36 and may cut power to the vehicle. Once the seal has been corrected, the operator may resume the evacuation of brake system 36 and may re-energize vehicle 38. The reintroduction of electric power to vehicle 38 will again result in transmission of actuating signal 60 (see FIG. 4). Processor 30 may be configured to check electronic data storage unit 32 upon receipt of actuating signal 60. If second file 72 has not been recorded in electronic data storage unit 32, then the automatic cycling of valves 28 will start over. If, however, processor 30 detects the presence of second file 72, processor 30 is configured to refrain from restarting the automatic cycling process of valves 28.

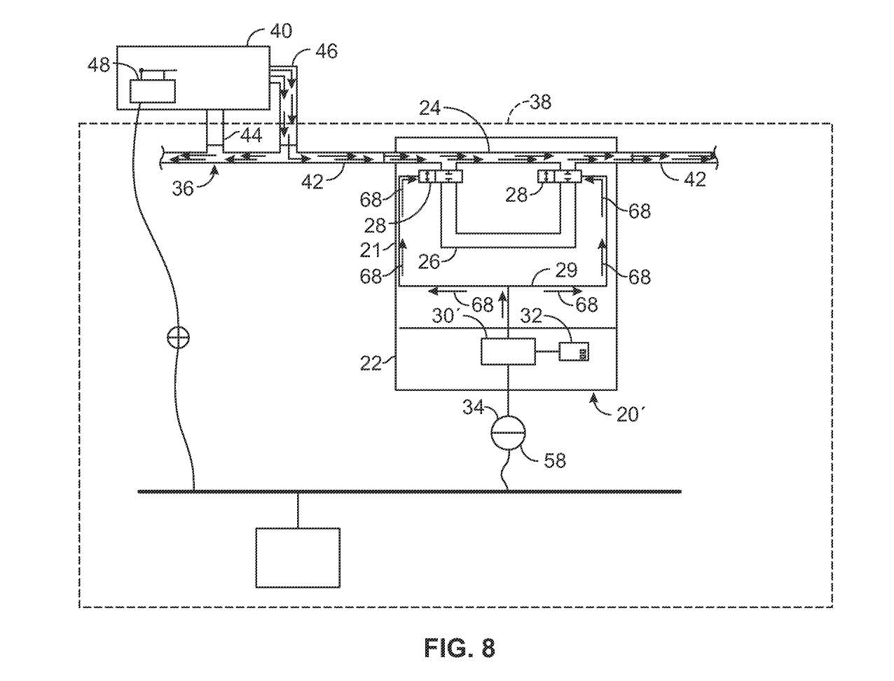

FIG. 8 is a schematic view of brake system 36 as brake system 36 is filled with hydraulic brake fluid. With continuing reference to FIGS. 1-8, in the illustrated embodiment, brake system 36 includes an alternate embodiment 20′ of the brake modulator which includes a processor 30′. Processor 30′ is substantially identical to processor 30 except that processor 30′ has been configured to transmit close instruction 68 to valves 28 prior to the filling of brake system 36 with hydraulic brake fluid. Processor 30′ may be configured to transmit close instruction 68 after the lapse of a predetermined period of time after the automatic cycling begins. Such a predetermined period of time may correspond with the length of time that brake system 36 is evacuated. Processor 30′ is further configured to maintain valves 28 in a closed state throughout the entire period that brake system 36 is filled with hydraulic brake fluid. Processor 30′ is configured in this manner because in some applications, it may be desirable to maintain a vacuum in secondary circuit 26 rather than filling secondary circuit 26 with hydraulic brake fluid.

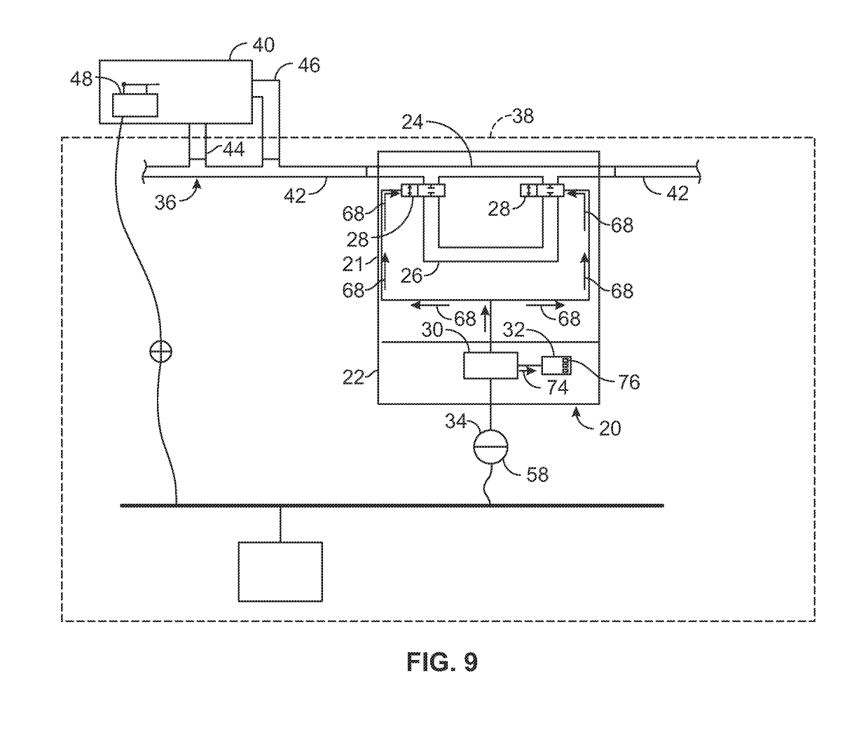

FIG. 9 is a schematic view of brake system 36 after completion of the automatic cycling of the valves 28 and after completion of the evacuation and filling of brake system 36 with hydraulic brake fluid. As illustrated, processor 30 sends close instruction 68 to valves 28 causing valves 28 to close, and thus complete the automatic cycling of valves 28. Processor 30 may be configured to send close instruction 68 to valves 28 once a predetermined period of time lapses after the start of the automatic cycling. Such a predetermined period of time may correspond with the total time required to evacuate and fill brake system 36 with hydraulic brake fluid. Processor 30 is further configured to send a third record instruction 74 to electronic data storage unit 32 which instructs electronic data storage unit 32 to store a third file 76. Third file 76 may include information indicating that the automatic cycling of valves 28 has progressed throughout the evacuation and filling of brake system 36 with hydraulic brake fluid and has successfully completed.

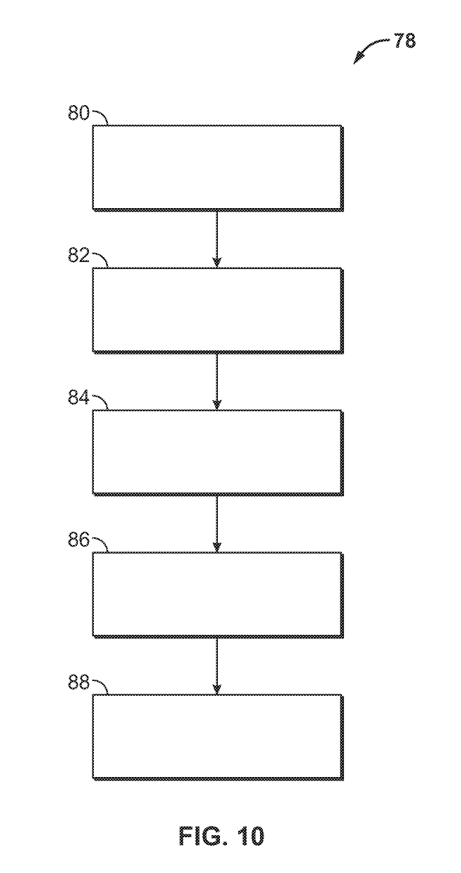

FIG. 10 is a block diagram illustrating an embodiment of a method 78 for processing a brake modulator during the assembly of a vehicle. With continuing reference to FIGS. 1-10, at block 80, a brake modulator, such as brake modulator 20, described above, is provided. Such a brake modulator will include a primary circuit configured for fluid coupling to a brake system of a vehicle, a secondary circuit that is in fluid communication with the primary circuit, one or more valves for controlling the flow of fluid between the primary and secondary circuits, and a processor for controlling the opening and closing of the valves.

At block 82, the brake modulator is connected to the brake system of the vehicle. During this step, brake lines on the vehicle are connected to the primary circuit of the brake modulator such that fluid may pass between the brake lines and the primary circuit.

At block 84, an automatic cycling of the valves of the brake modulator is actuated. At block 86, the automatic cycling of the valve occurs. The automatic cycling may last for a length of time substantially equal to the time required to evacuate the brake system. At block 88, the brake system of the vehicle and the brake modulator are evacuated while the automatic cycling of the valve occurs. The automatic cycling of the valve permits the evacuation of air from the secondary circuit.

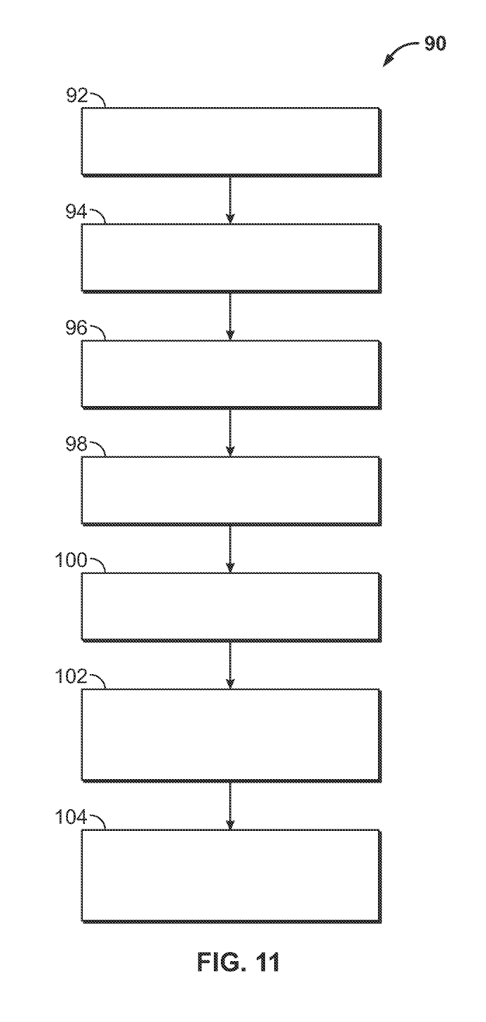

FIG. 11 is a block diagram illustrating another embodiment of a method 90 for processing a brake modulator during vehicle assembly. At block 92, a brake modulator is provided, as described above with respect to FIG. 10. At block 94, the brake modulator is connected to the brake system of the vehicle.

At block 96, the brake modulator is energized. Power may be provided by the vehicle battery, by processing equipment used to evacuate and fill the brake system with hydraulic brake fluid, or by any other suitable source.

At block 98, an actuating signal is transmitted to the brake modulator. The actuating signal may be transmitted by a component of the vehicle, such as the vehicle's body control module, by the equipment used to evacuate and fill the brake system with hydraulic brake fluid, or by any other component in communication with the brake modulator. The actuating signal is configured to actuate the brake modulator to begin an automatic cycling of the valves between the primary circuit and the secondary circuit.

At block 100, the automatic cycling of the valves occurs. Such automatic cycling may last for a period of time substantially equal to the length of time required to evacuate the brake system and to fill the brake system with hydraulic brake fluid.

At block 102, the brake system of the vehicle is evacuated while the automatic cycling of the valves takes place. The automatic cycling of the valves during this period permits any air in the secondary circuit to be evacuated.

At block 104, the brake system and the primary circuit and the secondary circuit are filled with hydraulic brake fluid. This occurs during the automatic cycling of the valves. The automatic cycling of the valves permits the secondary circuit to receive hydraulic brake fluid from the primary circuit.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A brake modulator for use with a brake system on a vehicle, the brake modulator comprising:
an electronic-brake-control-modulator portion including a processor; and
a hydraulic portion associated with the electronic-brake-control-modulator portion, the hydraulic portion including a primary circuit extending through the hydraulic portion and configured to receive a hydraulic brake fluid, the hydraulic portion further including a secondary circuit extending within the hydraulic portion and configured to receive the hydraulic brake fluid, the secondary circuit being in fluid communication with the primary circuit, and the hydraulic portion still further including a valve disposed between the primary circuit and the secondary circuit, the valve configured to be electronically actuatable and to control movement of fluid between the primary circuit and the secondary circuit,
wherein the processor is operatively coupled to the valve and configured to perform an automatic cycling of the valve in response to an actuating event during assembly of the vehicle wherein the valve is cycled to permit evacuation of the secondary circuit.

2. The brake modulator of claim 1, wherein the processor is configured to hold the valve open during the automatic cycling for substantially an entire period of time that the brake system is being evacuated.

3. The brake modulator of claim 1, wherein the processor is configured to open and close the valve a plurality of times during the automatic cycling while the brake system is being evacuated.

4. The brake modulator of claim 1, wherein the processor is configured to hold the valve closed during the automatic cycling for substantially an entire period of time that the brake system is being filled with the hydraulic brake fluid.

5. The brake modulator of claim 1, wherein the processor is configured to hold the valve open during the automatic cycling for substantially an entire period of time that the brake system is being filled with the hydraulic brake fluid.

6. The brake modulator of claim 1, wherein the processor is configured to open and close the valve multiple times during the automatic cycling while the brake system is being filled with the hydraulic brake fluid.

7. The brake modulator of claim 1, wherein the processor is configured to restart the automatic cycling if the automatic cycling is interrupted prior to completion.

8. The brake modulator of claim 7, wherein the processor is configured to restart the automatic cycling if the automatic cycling is interrupted prior to a lapse of a predetermined period of time.

9. The brake modulator of claim 8, wherein the predetermined period of time corresponds to a length of time that the brake system is evacuated.

10. The brake modulator of claim 1, wherein the processor is configured to inhibit a second occurrence of the automatic cycling once the automatic cycling has been completed.

11. The brake modulator of claim 10, wherein the processor is configured to inhibit the second occurrence of the automatic cycling once the automatic cycling has progressed for a predetermined period of time.

12. The brake modulator of claim 11, wherein the predetermined period of time corresponds to a length of time that the brake system is evacuated.

13. The brake modulator of claim 1, wherein the actuating event comprises energizing the electronic brake control module.

14. The brake modulator of claim 13, wherein the actuating event further comprises transmitting an actuating signal to the electronic brake control module.

15. The brake modulator of claim 1, further comprising an electronic data storage unit operatively coupled to the processor, the electronic data storage unit configured to store electronic data, wherein the processor is configured to instruct the electronic data storage unit to store data relating to a progression of the automatic cycling.

16. The brake modulator of claim 15, wherein the processor is further configured to instruct the electronic data storage unit to store a first data file containing information indicative of a commencement of the automatic cycling when the automatic cycling commences.

17. The brake modulator of claim 16, wherein the processor is further configured to instruct the electronic data storage unit to store a second data file containing information indicative of the automatic cycling having continued for a predetermined period of time after the automatic cycling has continued in an uninterrupted fashion for the predetermined period of time.

18. The brake modulator of claim 16, wherein the processor is further configured to instruct the electronic data storage unit to store a third data file containing information indicative of the automatic cycling having been completed after the automatic cycling has been completed.

19. A method for processing a brake modulator during assembly of a vehicle, the method comprising the steps of:
providing the brake modulator;
connecting the brake modulator to a brake system of the vehicle;
actuating an electronic-brake-control-module portion of the brake modulator to begin an automatic cycling of a valve disposed between a primary circuit and a secondary circuit of a hydraulic portion of the brake modulator;
conducting the automatic cycling of the valve; and
evacuating the brake system, the primary circuit and the secondary circuit of the hydraulic portion of the brake modulator during the automatic cycling of the valve.

20. A method for processing a brake modulator during assembly of a vehicle, the method comprising the steps of:
providing the brake modulator;
connecting the brake modulator to a brake system of the vehicle;
energizing an electronic-brake-control-module portion of the brake modulator;
transmitting an actuating signal to the electronic-brake-control-module portion configured to actuate an automatic cycling of a valve disposed between a primary circuit and a secondary circuit of a hydraulic portion of the brake modulator;
conducting the automatic cycling of the valve;
evacuating the brake system, the primary circuit and the secondary circuit during the automatic cycling of the valve; and
filling the brake system, the primary circuit and the secondary circuit with the hydraulic brake fluid during the automatic cycling of the valve.
